(19) United States
(12) Patent Application Publication
(10) Pub. No.: US 2025/0362270 A1
(43) Pub. Date: Nov. 27, 2025

(54) ULTRASONIC MULTIVARIABLE PROCESS TRANSMITTER

(71) Applicant: Rosemount Inc., Shakopee, MN (US)

(72) Inventors: Brian M. Affias, Prior Lake, MN (US); Jonathan M. Allin, Crawley (GB); Bennett L. Louwagie, Plymouth, MN (US); Scott Nelson, Plymouth, MN (US)

(21) Appl. No.: 19/214,383

(22) Filed: May 21, 2025

Related U.S. Application Data
(60) Provisional application No. 63/650,708, filed on May 22, 2024.

(51) Int. Cl. G01N 29/07; G01B 17/02

(52) U.S. Cl. CPC G01N 29/07; G01B 17/02; G01N 2291/011; G01N 2291/023; G01N 2291/02854; G01N 2291/2634

(57) ABSTRACT

An ultrasonic multivariable process transmitter includes an ultrasonic transmitter configured to transmit a pulse of input ultrasonic vibrations into a proximal surface of a wall. The pulse propagates through the wall and reflects from a distal surface to form a reflected pulse of output ultrasonic vibrations. An ultrasonic receiver receives pulses of ultrasonic vibrations at the proximal surface. Processing circuitry correlates the received reflected pulse of output ultrasonic vibrations with changes in the surface of the wall. The received pulses are further a function of a process variable of a process related to a process fluid in contact with a surface of the wall. An output indicative of the process variable of the process is provided.

### CROSS-REFERENCE TO RELATED APPLICATION

The present application is based on and claims the benefit of U.S. provisional patent application Ser. No. 63/650,708, filed May 22, 2024, the content of which is hereby incorporated by reference in its entirety.

### BACKGROUND

The present invention relates to measuring process variables in an industrial process. More particularly, the invention relates to measurement of such process variables using ultrasonic transmitters and sensors.

Industrial process variable transmitters are used to monitor operation and conditions in industrial processes. Example industrial processes include oil refineries, paper manufacturing, pharmaceutical production, and many others. The transmitters monitor process variables such as flow rate, pressure, temperature, liquid level, and others. Some process variables measurements, such as pressure and most process temperature measurements, are done through intrusive methods that require sensing devices to be in direct contact with process media. However, there are many applications where the process barrier interruption needed to access the process fluid is undesirable.

It is known to provide ultrasonic detectors which may be used to perform measurements in industrial process. One example measurement is to detect a change in a surface of a wall. Such a wall may, for example, be the wall of a pipe or conduit containing a fluid, such as a corrosive fluid or a multi-phase fluid. Such fluids may corrode or erode the inner surface of the wall, and it is desirable to monitor such changes in the thickness of the wall or changes in the roughness of the inner wall. By monitoring in this way, potential failures and risks can be identified before a problem arises.

There is an ongoing need to measure different types of process variables in industrial processes.

### SUMMARY

An ultrasonic multivariable process transmitter includes an ultrasonic transmitter configured to transmit a pulse of input ultrasonic vibrations into a proximal surface of a wall. The pulse of input ultrasonic vibrations propagate through the wall and reflect from a distal surface of the wall to form a reflected pulse of output ultrasonic vibrations at the proximal surface. An ultrasonic receiver receives ultrasonic pulses of ultrasonic vibrations including the reflected pulse of output ultrasonic vibrations at the proximal surface. Processing circuitry correlates a sequence of sample values of the received reflected pulse of output ultrasonic vibrations with changes in the surface of the wall. The received pulses of ultrasonic vibrations are further a function of a process variable of a process related to a process fluid in contact with a surface of the wall, and the processing circuitry provides an output indicative of the process variable of the process. Output circuitry is configured to provide an output indicative of changes in the surface of the wall and of the process variable of the process.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

FIG. 1 schematically illustrates a system for monitoring multiple process variables such as pipe wall thickness using an ultrasonic signal.

FIG. 2 schematically illustrates the propagation of pulses of ultrasonic vibrations through a pipe wall.

FIG. 3 schematically illustrates the reflection of ultrasonic vibrations from a surface of a pipe wall.

FIG. 4 is a cross-sectional view of a process vessel, in this case a pipe, coupled to a plurality of ultrasonic multivariable process transmitters.

FIG. 5 is a simplified block diagram of electrical circuitry of a ultrasonic multivariable process transmitter.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

It is known to use ultrasonic measurement techniques to measure corrosion and wall thicknesses in industrial processes. For example, Rosemount Inc. offers a portfolio of industry leading wireless ultrasonic corrosion and erosion detection products that monitor and track the wall thicknesses of process vessels which carry process for product asset management, safety, and environmental compliance. These process variable transmitters use a non-intrusive Electromagnetic Acoustic Transducer (EMAT) to measure time of flight of reflected acoustic waves through the pipe material to provide extremely accurate estimates of changes in wall thickness and internal surface conditions. To perform this wall thickness measurement with a sufficient level of accuracy, other real-time application conditions preferably need to be minimized. This includes compensating for the effects of ambient and process temperature and the pipe material. This compensation is done through product design and active compensation techniques, for example, compensation of ultrasonic measurements based on changes in temperature of various components including the process fluid. The process variable transmitters include an EMAT sensor that is mounted directly on the process vessel, which may be a pipe, tank, or other container or conduit. A wave guide is typically used to transfer an acoustic signal from the EMAT to the surface of the process vessel. Electronics in the device analyze and transform the raw sensor data into a corrected process variable output indicative of wall thickness and/or interior surface condition.

In one aspect, the present invention utilizes data obtained with such an ultrasonic sensing device to acquire additional process variables related to operation of the industrial process.

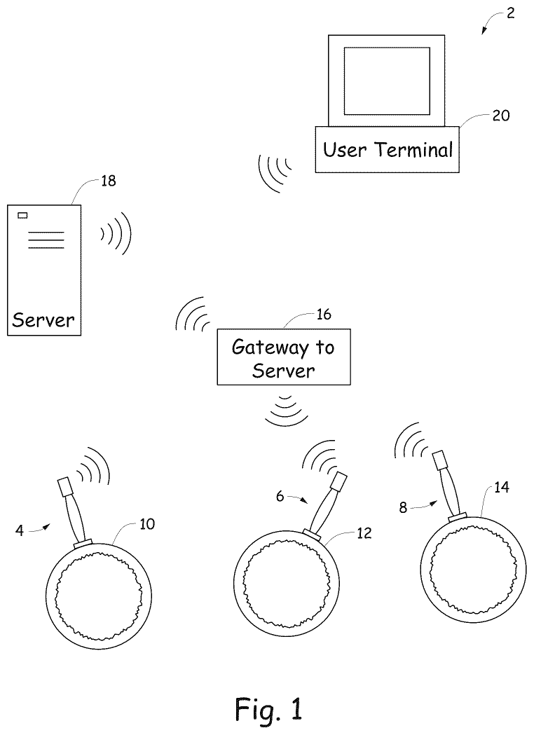

FIG. 1 schematically illustrates a system 2 for monitoring pipe wall thickness comprising a plurality of process variable transmitters, or sensors, 4, 6, 8 each attached to a respective pipe 10, 12, 14. Each pipe has an outer surface corresponding to a proximal surface to which one of the sensors 4, 6, 8, are attached and an inner surface corresponding to a distal surface from which reflections of pulses of ultrasonic vibrations are detected. The pipe may carry a corrosive fluid or a mixed phase fluid which subjects the inner surface of the pipe to corrosion and/or erosion (e.g. sand within crude oil may erode the inner surface of pipe). In this example configuration, each of the sensors 4, 6, 8 communicates wirelessly with a gateway 16 either directly or via a mesh network formed of the sensors. The gateway 16 in turn communicates with a server 18. The sensor 4, 6, 8 illustrated in FIG. 1 are waveguide sensors well suited to high temperature applications, but other sensor types are possible, such as pulse echo mode sensors (same transducer sends and receives) that may be suited to lower temperature environments.

At periodic intervals, such as every 12 hours (or less if more frequent monitoring is required), each of the sensors 4, 6, 8 may perform a determination of the thickness of a vessel wall, such as pipe wall thickness of the pipes 10, 12, 14 to which it is attached. This test may be performed by transmitting a pulse of input ultrasonic vibrations into a proximal surface of the pipe wall (either directly or indirectly) and then reflected ultrasonic vibrations returned back to the proximal surface. The received vibrations may be sampled with a high rate analog-to-digital converter and then wirelessly transmitted via the gateway 16 to the server 18. The server 18 may then perform signal processing upon these signals representing the received ultrasonic vibrations at the proximal surface in order to identify a propagation delay of the ultrasonic pulses through the pipe walls and accordingly the pipe wall thicknesses. This signal processing can a comparison of the received ultrasonic vibrations with a previously detected pulse of output ultrasonic vibrations that was received at the proximal surface, in order to identify a time of arrival of a current pulse of output ultrasonic vibrations. This comparison may use cross-correlation, cross-covariance, a similarity function or other forms of comparison seeking to match received ultrasonic vibrations with a previously detected pulse of output ultrasonic vibrations. Any techniques can be used to correlate the received ultrasonic signal to wall thickness or interior wall condition. The analysis performed may determine the pipe wall thickness, but may also or alternatively be used to detect other changes in the distal (inner) surface of the pipe, such as changes in the inner surface profile of the pipe due to different types of corrosion/erosion. Other measurement techniques may also be used, including those that do not perform a comparison, operate in the frequency domain, or other techniques. As discussed below in more detail, the analysis of the reflected ultrasonic signals can be used to provide additional process variables which are obtained without a physical intrusion through a process barrier to obtain direct access to the process fluid.

The results of the analysis by the server 18 can be sent to a user terminal 20 where they can be displayed and interpreted by a user of the system. Further, server 18 can be used to aggregate the measurements from multiple sensors 4,6,8 in order to determine additional process variables. It will be appreciated that the pipes 10, 12, 14, the sensors 4, 6, 8 and the gateway 16 may be at a different physical location (such as in a completely different country) from the server 18 and in turn to the user terminal 20. The present techniques are well suited to remote monitoring of large scale plants, such as oil refineries or chemical processing plants.

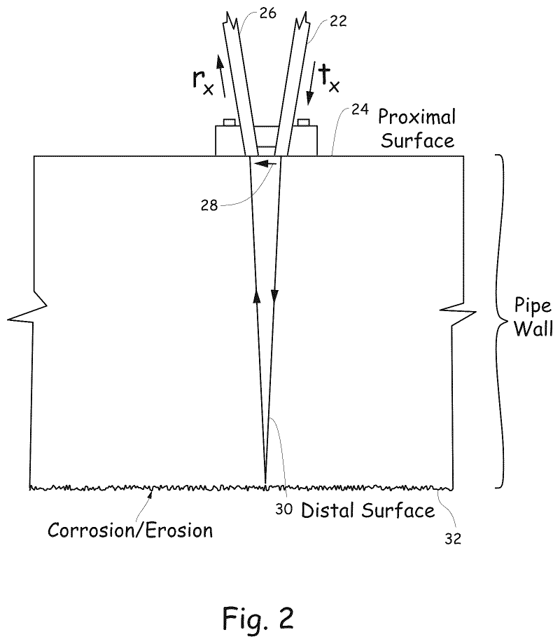

FIG. 2 schematically illustrates the propagation of a pulse of ultrasonic vibrations through a pipe wall. The pulse of ultrasonic vibrations may be transmitted along a transmitting waveguide 22 to a proximal surface 24 of the pipe wall. The coupling to the proximal surface 24 may be direct or indirect. Received ultrasonic vibrations pass into a receiving waveguide 26 from the proximal surface 24 some time after the input pulse was sent into the pipe wall. The generation of ultrasound can be generalized into methods that produce vibrations which need to be coupled to the pipe (conventional piezo electric for example) or methods that induce/create vibrations in the pipe (EMAT, laser, for example), without needing direct contact.

Also illustrated in FIG. 2, a direct path 28 is provided between the transmitting waveguide 22 and the receiving waveguide 26. This direct path gives rise to a reference pulse of ultrasonic vibrations that may be used to compensate for the transmission times along the waveguides 22, 26 as well as other effects, such as delays in the triggering and transmission of the pulse. (other transducers operating in a pulse echo mode may use reflection from the proximal surface as the timing trigger). A first-order reflecting path 30 through the wall is illustrated showing the input ultrasonic vibrations propagating through the thickness of the wall, reflecting from a distal surface 32 of the wall and then returning through the thickness of the wall back to the proximal surface 24 where they form the current pulse of output ultrasonic vibrations for which the arrival time is detected using the cross-correlation, cross-co-variance, similarity functions or other forms of comparison. Determining the arrival time of this current pulse of output ultrasonic vibrations relative to the arrival time of the reference pulse permits a propagation delay time to be calculated corresponding to the propagation through the thickness of the pipe wall using standard trigonometry. This propagation delay may in return be used to determine a wall thickness and monitor factors such as the rate of corrosion or the rate of erosion of the wall.

Other than vessel wall thickness measurements, most process variables are measured using intrusive measurement techniques in which a process variable sensor is in contact with the process fluid. For example, pressure and most process temperature measurements are obtained through intrusive methods that require sensor devices to be in direct contact with process media. However, there are many industrial process applications where process barrier interruptions are undesirable.

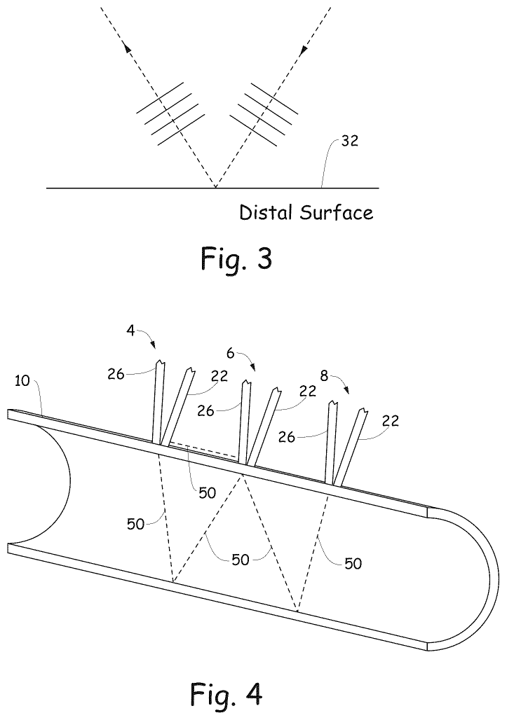

FIG. 3 schematically illustrates the reflection of a pulse of ultrasonic vibrations from a distal surface 32. The time of flight of the return pulse from surface 32 can be measured and used to determine wall thickness. Further, additional process variables can be measured using returned ultrasonic pulses. Changes in waveform, phase, or other parameters of the return pulse can be used to determine process variables. In addition to the return pulse from surface 32, additional return pulses can be utilized. These include pulses from another wall, including an opposing wall, other elements placed in the process fluid, and ultrasonic pulses transmitted from other sensors. Example process variables that can be determined from these return pulses include temperature, pressure, flow rate, turbidity, liquid level, volume, mass, and others.

With the present invention, additional process variables can be measured with these same ultrasonic measurement device. In addition to wall thickness, other process variables affect the propagation of the ultrasonic signal. By detecting these changes in propagation, additional process variables can be sensed and measured using, for example, the same EMAT sensor used to measure wall thickness. This can be done using any desired technique. For example, the technique used to compensate wall thickness measurements due to other process variables, such as temperature, can itself be utilized to determine the additional process variable from the reflected ultrasonic signal. Other algorithms and data matching techniques can also be used including machine learning, curve fitting, system modeling, etc. This technique provides the ability to resolve process variables such as flow conditions, interior wall temperature, internal pressure, viscosity, and other variables using the same EMAT technology used to measure wall thickness. This provides a single device that senses more than one process variable.

In one configuration, wall thickness measurement is determined using a multipoint system by employing an array of different EMAT thickness measurement devices, as illustrated in FIG. 4. In FIG. 4, sensors 4, 6 and 8 are arranged at different locations along pipe 10, which is shown in cross section. In addition to the reflected ultrasonic signal from distal surface 30 shown in FIG. 2, reflected ultrasonic signals 50 are communicated between sensors 4, and 8. The ultrasonic signals 50 can be travel through process fluid carried in pipe 10 and be reflected from another side of pipe 10, including an opposite side. Further, ultrasonic signals 50 can travel along the pipe wall between sensors 4, 6 and 8. By combining a plurality of ultrasonic multivariable process transmitters in a similar multipoint installation, device level or system level process diagnostic tools can be used to provide insight into the operation of the process and condition of process components. Because of the non-intrusive nature resulting in lower risks related to process containment risks than traditional intrusive techniques, the invention provides a number of advantages over existing techniques. Examples include but are not limited to valve health, filter health, multiphase flow applications, additional pipe containment health information, and other process variables.

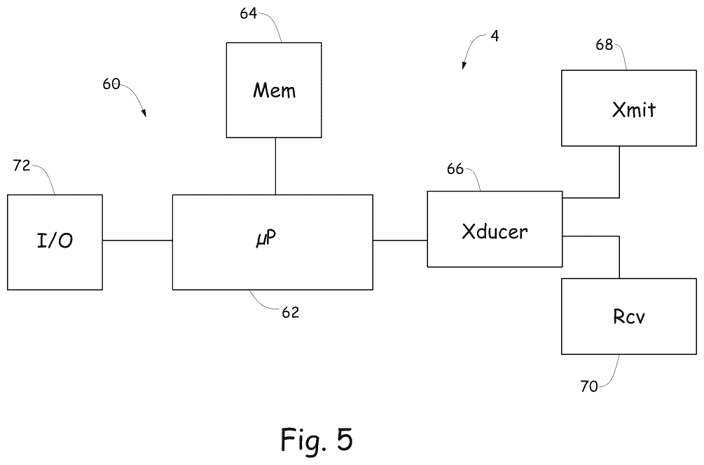

FIG. 5 is a simplified block diagram illustrating electronics of ultrasonic multivariable process transmitter 4. Transmitter 4 includes processing circuitry 60 having a microprocessor 62 which operates in accordance with instructions stored in a memory 64. However, similar circuitry and configurations can also be used. An EMAT transducer is illustrated as transducer 66, ultrasonic transmitter 68 and receiver 70. I/O circuitry 72 can be used to communicate with an operator, and/or communicate with a remote location such as a process control room, gateway server 16, server 18 and/or other ultrasonic multivariable process transmitters.

In operation, microprocessor 62 is configured to actuate transducer circuitry 66 to transmit an ultrasonic signal using transmitter 68. Receiver 70 is arranged to receive reflected ultrasonic signals which are provided to transducer 66, digitized and provided to microprocessor 62. As discussed, the reflected ultrasonic signals can be correlated to process variables including wall thickness, temperature, flow rate, pressure, etc. This correlation can be done using information stored in memory 64, or at a location such as server 18 or user terminal 20 illustrated in FIG. 1. As discussed in connection with FIG. 4, ultrasonic receiver 70 can receive reflected ultrasonic pulses from multiple locations including multiple walls or interfaces, other transmitters coupled to the industrial process, as well as from a process fluid itself including multiphase components carried in a process fluid.

Various different techniques can be used to determine different process variables which alter the reflected or otherwise received ultrasonic signal received by receiver 70. For example, temperature of a process component can be determined based upon the time of flight of the reflected signal. This is because the velocity of ultrasonic signals within the material varies as a function of temperature. In another example, pressure can be determined because the ultrasonic properties of a body change in response to the stress or strain applied to the body. Using this effect, it is possible to determine the pressure that is being applied to the body by, for example, process fluid that is carried by the body or in contact with the body. In yet another example, the transmitter can measure flow rate of a process fluid. A number of different techniques can be used to determine flow rate. These include measuring a Doppler shift in an ultrasonic signal, measuring the transmit time of an ultrasonic signal, and correlation of an ultrasonic signal transmitted between multiple ultrasonic sensors. The viscosity of a process fluid can be measured using ultrasonic signals using a number of techniques. One example technique is by measuring reflection of ultrasonic signals from a fluid interface.

In one aspect, a first reflected signal is generated at a proximal surface of a precess vessel wall. A second reflected signal is generated at a distal surface of the wall. Additional reflections can be generated at other surfaces, including an opposed wall, such as a wall on an opposite side of a pipe or vessel, an interface surface between layers in a multiphase fluid, a surface of an objected, carried in a fluid, or other reflective sources. In addition to reflected ultrasonic signals, an ultrasonic receiver can receive an ultrasonic signal from an ultrasonic transmitter of another process variable transmitter. The signal can be carried in a process fluid or a wall or other component used in an industrial process and directly received, and can also be a reflected signal reflected from a surface.

Although the present invention has been described with reference to preferred embodiments, workers skilled in the art will recognize that changes may be made in form and detail without departing from the spirit and scope of the invention. Corrosion and erosion ultrasonic products are non-intrusive devices that can be adapted to measure more than wall thickness, indicating wear due to abrasion or chemical exposure. The fundamental EMAT technology can interrogate process conditions such as internal wall temperature and pressure contained within a process vessel. A device that measures more than one process variable using this EMAT technology is provided. Multiple devices can be used to determine an expanded holistic condition of the industrial process and related equipment. The output provided by the I/O circuitry can be configured by a user to select between output variables on an instrumentation loop, or multiple variables over digital protocols. These include, for example, HART®, Foundation Field bus, WirelessHART®, cellular, and others. The processing circuitry can be located within the transmitter, near the transmitter, or at a remote location. For example, gateway 16 or server 18 can perform the processing to determine the process variable(s). In such a configuration, information related to the received ultrasonic pulse is communicated to the remote location. The output circuitry can be located at the remote location to provide an output related to the determined process variable(s). To measure pressure, EMATS can be advantageous because the signal variations due to pressure are much smaller than those due to temperature. However, by placing 2 EMATs orthogonally, the system can measure the strain in 2 directions and used to eliminate the temperature effect. In one aspect, a transducer/system is provided which makes measurements of multiple process variable using ultrasonic vibrations. This provides the ability to make multiple process variable measurements with ultrasound in the same transducer, thereby reducing cost and complexity. The EMAT transducer may need to have several coils and magnet arrangements to make different measurements (e.g. orthogonal racetrack coils for producing different polarizations of shear waves to obtain temperature compensation for pressure measurements). The ultrasonic transmitter and received can be configured in the same transducer.

What is claimed is:

1. An ultrasonic multivariable process transmitter, comprising:
an ultrasonic transmitter configured to transmit a pulse of input ultrasonic vibrations into a proximal surface of a wall, the pulse of input ultrasonic vibrations propagating through the wall and reflecting from a distal surface of the wall to form a reflected pulse of output ultrasonic vibrations at the proximal surface;
an ultrasonic receiver configured to receive ultrasonic pulses of ultrasonic vibrations including the reflected pulse of output ultrasonic vibrations at the proximal surface;
processing circuitry configured to correlate a sequence of sample values of the received reflected pulse of output ultrasonic vibrations with changes in the distal surface of the wall, wherein the received pulses of ultrasonic vibrations are further a function of a process variable of a process related to a process fluid in contact with a surface of the wall, and the processing circuitry is configured to provide an output indicative of the process variable of the process; and
output circuitry configured to provide an output indicative of changes in the surface of the wall and of the process variable of the process.

2. The ultrasonic multivariable process transmitter of claim 1 wherein the process variable comprises pressure.

3. The ultrasonic multivariable process transmitter of claim 1 wherein the process variable comprises temperature.

4. The ultrasonic multivariable process transmitter of claim 1 wherein the process variable comprises flow rate.

5. The ultrasonic multivariable process transmitter of claim 1 wherein the received pulse includes an ultrasonic signal from a fluid interface.

6. The ultrasonic multivariable process transmitter of claim 1 wherein the received pulse includes an ultrasonic signal from an opposed surface of a process vessel.

7. The ultrasonic multivariable process transmitter of claim 1 wherein the received pulse includes an ultrasonic signal from another ultrasonic multivariable process transmitter.

8. The ultrasonic multivariable process transmitter of claim 1 wherein the process variable comprises viscosity.

9. The ultrasonic multivariable process transmitter of claim 1 including at least one additional ultrasonic multivariable transmitter used to provide a holistic multipoint measurement of a specific industrial process.

10. The ultrasonic multivariable process transmitter of claim 1 including I/O circuitry configured to allow a user to select between output variables on an instrumentation loop, or multiple variables over digital protocols.

11. The ultrasonic multivariable process transmitter of claim 1 wherein the process variable is determined based upon time of flight.

12. The ultrasonic multivariable process transmitter of claim 1 wherein the process variable is determined based upon a waveform profile.

13. The ultrasonic multivariable process transmitter of claim 1 wherein the process variable is determined based upon a correlation with ultrasonic waveform information stored in a memory.

14. The ultrasonic multivariable process transmitter of claim 1 wherein the proximal and distal surfaces of the wall form an integral conduit configured to receive process fluid flowing through the conduit.

15. The ultrasonic multivariable process transmitter of claim 1 wherein the proximal and distal faces of the wall constitute outer and inner faces of the conduit.

16. A method of measuring process variables using an ultrasonic multivariable process transmitter, comprising:
transmitting a pulse of input ultrasonic vibrations into a proximal surface of a wall, the pulse of input ultrasonic vibrations propagating through said wall and reflecting from a distal surface of the wall to form a reflected pulse of output ultrasonic vibrations at the proximal surface;
receiving ultrasonic pulses of ultrasonic vibrations including the reflected pulse of output ultrasonic vibrations at the proximal surface; and
correlating a sequence of sample values of the received reflected pulse of output ultrasonic vibrations with changes in the distal surface of the wall, wherein the received pulses of ultrasonic vibrations is further a function of a process variable of a process related to a process fluid in contact with the distal surface of the wall;
correlating the received reflected pulse of output ultrasonic vibrations with the process variable; and
outputting information indicative of changes in the surface of the wall and of the process variable of the process.

17. The method of claim 16 wherein the process variable comprises pressure.

18. The method of claim 16 wherein the process variable comprises temperature.

19. The method of claim 16 wherein the process variable comprises flow rate.

20. The method of claim 16 wherein the received pulses include an ultrasonic signal from a fluid interface.

21. The method of claim 16 wherein the received pulses includes an ultrasonic signal from an opposed surface of a process vessel.

22. The method of claim 16 wherein the process variable comprises viscosity.

23. An ultrasonic multivariable process measurement system, comprising:
an ultrasonic transmitter configured to transmit a pulse of input ultrasonic vibrations into a proximal surface of a wall, the pulse of input ultrasonic vibrations propagating through the wall and reflecting from a distal surface of the wall to form a reflected pulse of output ultrasonic vibrations at the proximal surface;
an ultrasonic receiver configured to receive ultrasonic pulses of ultrasonic vibrations including the reflected pulse of output ultrasonic vibrations at the proximal surface;
communication circuitry configured to communicate information to a remote location, the information related to a sequence of sample values of the received reflected pulse of output ultrasonic information;
processing circuitry at the remote location configured to correlate the sequence of sample values of the received reflected pulse of output ultrasonic vibrations with changes in the distal surface of the wall, wherein the received pulses of ultrasonic vibrations are further a function of a process variable of a process related to a process fluid in contact with a surface of the wall, and the processing circuitry is configured to provide an output indicative of the process variable of the process; and
output circuitry configured to provide an output indicative of changes in the surface of the wall and of the process variable of the process.
